(19) United States
(12) Patent Application Publication
(10) Pub. No.: US 2025/0045352 A1
(43) Pub. Date: Feb. 6, 2025

(54) ACCELERATED APPROXIMATIONS OF FUNCTIONS

(71) Applicant: INTERNATIONAL BUSINESS MACHINES CORPORATION, ARMONK, NY (US)

(72) Inventors: ROBERT FREDERICK ENENKEL, MARKHAM (CA); CHRISTOPHER ANAND, DUNDAS (CA); SILVIA MELITTA MUELLER, ST. INGBERT (DE)

(21) Appl. No.: 18/364,629

(22) Filed: Aug. 3, 2023

(51) Int. Cl. G06F 17/17

(52) U.S. Cl. CPC G06F 17/17

(57) ABSTRACT

Accelerated approximations of functions, including: approximating, by a computing device, a hyperbolic tangent function applied to an input by: where the input is less than zero: performing a first exponentiation comprising raising a first base of two to a first exponent equal to double the input; and subtracting one from a result of the first exponentiation; and where the input is greater than zero, subtracting from one a result of a second exponentiation comprising raising a second base of two to a second exponent equal to a negative of double the input.

### BACKGROUND

### Field of the Invention

The field of the invention is data processing, or, more specifically, methods, apparatus, and products for accelerated approximations of functions.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Sigmoid functions and hyperbolic tangent functions are used in a variety of applications, including image processing and artificial intelligence. Each of these functions use division and exponentiation, which themselves are computationally expensive, as are existing approximations meeting a level of accuracy needed for these applications. The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 shows a graph comparing a plot of a hyperbolic tangent function to a plot of an approximated hyperbolic tangent function according to some embodiments of the present disclosure.

FIG. 2 shows a graph comparing a plot of a sigmoid function to a plot of an approximated sigmoid function according to some embodiments of the present disclosure.

FIG. 3 shows a graph comparing a plot of an exponential linear unit (ELU) function to a plot of an approximated ELU function according to some embodiments of the present disclosure.

FIG. 4 shows a block diagram of an example hardware implementation for accelerated approximations of functions according to some embodiments of the present disclosure.

FIG. 5 shows a block diagram of an example computer for accelerated approximations of functions according to some embodiments of the present disclosure.

FIG. 6 shows a flowchart of an example method for accelerated approximations of functions according to some embodiments of the present disclosure.

FIG. 7 shows a flowchart of another example method for accelerated approximations of functions according to some embodiments of the present disclosure.

FIG. 8 shows a flowchart of another example method for accelerated approximations of functions according to some embodiments of the present disclosure.

FIG. 9 shows a flowchart of another example method for accelerated approximations of functions according to some embodiments of the present disclosure.

FIG. 10 shows a flowchart of another example method for accelerated approximations of functions according to some embodiments of the present disclosure.

FIG. 11 shows a flowchart of another example method for accelerated approximations of functions according to some embodiments of the present disclosure.

### SUMMARY

Accelerated approximations of functions may include: approximating, by a computing device, a hyperbolic tangent function applied to an input by: where the input is less than: performing a first exponentiation comprising raising a first base of two to a first exponent equal to double the input; and subtracting one from a result of the first exponentiation; and where the input is greater than zero, subtracting from one a result of a second exponentiation comprising raising a second base of two to a second exponent equal to a negative of double the input.

### DETAILED DESCRIPTION

Sigmoid functions, hyperbolic tangent functions, and ELU functions are used in a variety of applications, including image processing and artificial intelligence. A sigmoid function may be represented by the following formula:

$$σ ( x ) = \frac{1}{1 + {e}^{- x}} ,$$

a hyperbolic tangent function may be represented by the following formula:

$$tanh ( x ) = \frac{{e}^{x} - {e}^{- x}}{{e}^{x} + {e}^{- x}} ,$$

and an ELU function may be represented by the following formula:

$$ELU ( x ) = \{ \begin{matrix}{e}^{x} - 1 , x \leq 0 \\ x , x > 0\end{matrix} .$$

As shown, each of these functions use exponentiation, and sigmoid and tanh also use division, which are computationally expensive. Existing approaches for approximating these functions at a requisite level of accuracy are also computationally expensive. Moreover, some applications such as optimizations or machine learning training and inference use derivatives of these functions. Approximating these derivatives may also introduce error or may be computationally expensive. Accordingly, approaches set forth herein describe approximations for both sigmoid functions and hyperbolic tangent functions that are both comparatively computationally efficient and accurate with respect to their respective approximated functions.

A hyperbolic tangent function may be approximated using the function

$${f}_{1} ( x ) = \{ \begin{matrix}{2}^{2 x} - 1 , x \leq 0 \\ 1 - {2}^{- 2 x} , x > 0\end{matrix} .$$

Here, where the input x is less than or equal to zero, the output may be calculated by performing an exponentiation whereby a base of two is raised to an exponent equal to double the input, and then subtracting one from the result of the exponentiation. Where the input is greater than zero, the output may be calculated by subtracting from one a result of an exponentiation whereby a base of two is raised to an exponent equal to a negative of double the input.

A sigmoid function may be approximated using the function

$${f}_{2} ( x ) = \{ \begin{matrix}0.5 \cdot {2}^{0.875 x} , x \leq 0 \\ 1 - 0.5 \cdot {2}^{- 0.875 x} , x > 0\end{matrix} .$$

Here, where the input x is less than or equal to zero, the output may be calculated by halving the result of an exponentiation whereby a base of two is raised to an exponent equal to seven-eighths of the input. Where the input is greater than zero, the output may be calculated by subtracting from one a half of the result of an exponentiation whereby a base of two is raised to an exponent equal to a negative of seven-eighths of the input.

An ELU function may be approximated using the function

$${f}_{3} ( x ) = \{ \begin{matrix}\frac{1}{2 log 2} ( {2}^{2 x} - 1 ) , x \leq 0 \\ x , x > 0\end{matrix} .$$

Here, where the input x is less than or equal to zero, the output may be calculated by performing an exponentiation whereby a base of two is raised to an exponent equal to double the input, subtracting one from the result of the exponentiation, and then multiplying by a constant equal to one divided by double the logarithm (base e) of two. Where the input x is greater than zero, the output is equal to the input.

Although the preceding example approximate functions use a particular subfunction where the input is equal to zero (e.g., where the input is less than or equal to zero), one skilled in the art will appreciate that either subfunction may be used where the input is equal to zero as either subfunction will result in the same output for an input zero. Moreover, in some embodiments, for an input zero, a known default value may be output instead of performing a particular calculation (e.g., zero for the hyperbolic tangent function and the ELU function, and 0.5 for the sigmoid function).

As shown, the approximated hyperbolic tangent function, the approximated sigmoid function, and the approximated ELU function, lack the computationally expensive division operations found in the functions being approximated, instead only using subtraction, multiplication, and exponentiation. In contrast to the functions being approximated which use exponentiations of base e, the exponentiations in the approximated hyperbolic tangent function and the approximated sigmoid function use exponentiations of base two. Accordingly, the exponents may be efficiently calculated using bit shifts. For example, an exponent of 0.5x may be calculated as x>>1. An exponent of 2x may be calculated as x<<1. An exponent of 0.875x may be calculated as x−x/8, which is equal to x−(x>>3). These example bit shifts assume that x is either provided as a fixed-point number, or is provided as a floating-point number and has been converted in the hardware arithmetic unit to fixed point. Accordingly, in some embodiments, the approaches set forth herein may be configured to use fixed-point inputs. In some embodiments, the approaches set forth herein may be configured to use floating-point inputs that may be converted to fixed-point values. By approximating hyperbolic tangent functions and sigmoid functions using simple arithmetic operations and bit shifts, both the approximated hyperbolic tangent function and the approximated sigmoid function are more computationally efficient compared to their respective functions being approximated and may be implemented even on lower-power processors such as on mobile devices.

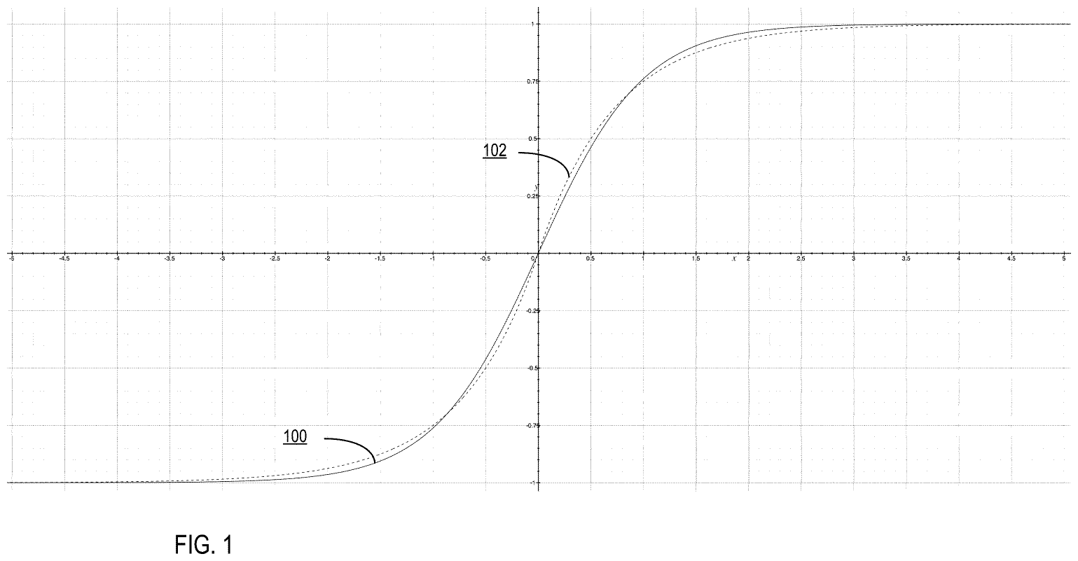

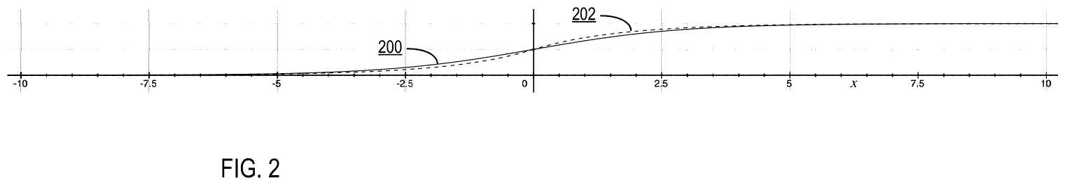

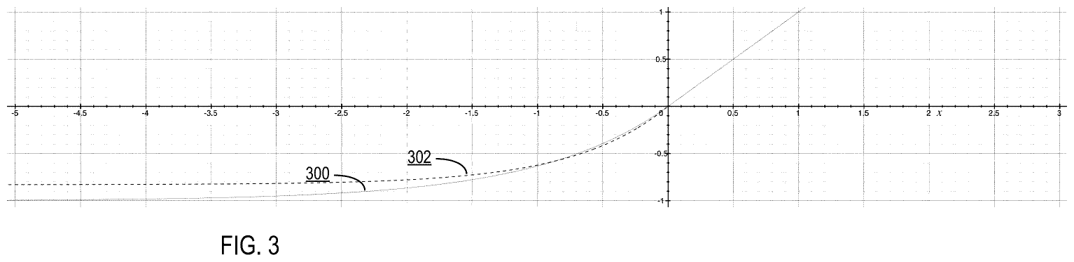

FIGS. 1, 2 and 3 show the accuracy of the approximated hyperbolic tangent function, the approximated sigmoid function, and the approximated ELU function compared to a hyperbolic tangent function, sigmoid function, and ELU function, respectively. Referring to FIG. 1, shown is a graph including a plot 100 of a hyperbolic tangent function and a plot 102 of an approximated hyperbolic tangent function. FIG. 2 shows a graph including a plot 200 of a sigmoid function and a plot 202 of an approximated sigmoid function. FIG. 3 shows a graph including a plot 300 of an ELU function and a plot 302 of an approximated ELU function. As shown, the approximated hyperbolic tangent function and the approximated sigmoid function are highly accurate compared to the hyperbolic tangent function and sigmoid function, respectively, as their plots closely match the shape of the plots of the respective functions being approximated, as do their respective output ranges (e.g., [−1,1] for a hyperbolic tangent function and [0,1] for a sigmoid function). The approximated ELU function closely approximates the shape of the ELU function for x>=−1, and shows similar asymptotic behavior to the ELU function for x<−1.

In some embodiments, the approximated hyperbolic tangent function, the approximated sigmoid function, and the approximated ELU function may each be implemented using a respective single hardware instruction. In other words, a processing unit may include, in its hardware instruction set, a single instruction that causes an approximated hyperbolic tangent function to be performed, another single instruction that causes an approximated sigmoid function to be performed, and another single instruction that causes an approximated ELU function to be performed. In some embodiments, each of these single instructions may be included in an instruction set that also includes instructions for hyperbolic tangent functions, sigmoid functions, or ELU functions. In some embodiments, each of these single instructions may be included in an instruction set that excludes other instructions for hyperbolic tangent functions, sigmoid functions, or ELU functions. In other words, each of these single instructions may be included in an instruction set instead of instructions for hyperbolic tangent functions, sigmoid functions, or ELU functions.

As is set forth above, some applications may require the use of derivatives of hyperbolic tangent functions or sigmoid functions. The derivative of a hyperbolic tangent function may be represented by the formula tanh′(x)=4/(e^{x}+e^{-x})² while the derivative of a sigmoid function may be represented by the formula σ′(x)=σ(x)²e^{-x}. Here, the derivative of the hyperbolic tangent function includes expensive division and exponentiation operations while the derivative of the sigmoid function includes an expensive exponentiation operation and sigmoid function.

The derivatives of the approximated hyperbolic tangent function, approximated sigmoid function, and approximated ELU function may be used instead of the derivatives of the hyperbolic tangent function, sigmoid function and ELU function, maintaining accuracy while improving computational efficiency. The derivatives of the approximated hyperbolic tangent function and approximated sigmoid function are, at most, one multiplication more complex than their respective approximated functions, while the derivative of the approximated ELU function is simpler than the approximated ELU function. The derivative of the approximated hyperbolic tangent function may be represented by the formula f₁′(x)=2·log(2)·2^{-|2x|}. Here, the derivative of the approximated hyperbolic tangent function may be calculated for an input x by multiplying, by two times a logarithm (base e) of two, the result of an exponentiation whereby a base of two is raised to an exponent equal to a negative of an absolute value of double the input. The derivative of the approximated sigmoid function may be represented by the formula f₂′(x)=0.4375·log(2)·2^{-0.875|x|}. Here, the derivative of the approximated sigmoid function may be calculated by multiplying, by seven-sixteenths of a logarithm (base e) of two, the result of an exponentiation whereby a base of two is raised to an exponent equal to negative-seven-eighths of an absolute value of the input. The derivative of the approximated ELU function may be represented by the formula

$${f}_{3}^{′} ( x ) = \{ \begin{matrix}{2}^{2 x} , x \leq 0 \\ 1 , x > 0\end{matrix} .$$

As with the approximated hyperbolic tangent function, approximated sigmoid function, and approximated ELU function, in some embodiments, the derivatives of the approximated hyperbolic tangent function, approximated sigmoid function, and approximated ELU function may each be implemented using a respective single hardware instruction in the instruction set of a processing unit. In other embodiments the derivatives of the approximated hyperbolic tangent function, approximated sigmoid function, and approximated ELU function may each be implemented using two respective hardware instructions in the instruction set of a processing unit. In other embodiments, an immediate argument to a hardware instruction can select one of multiple functions or their derivatives to be approximated.

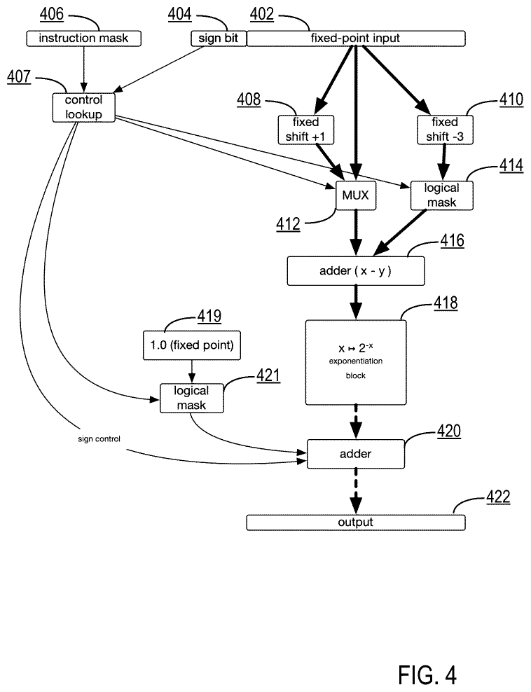

FIG. 4 shows a block diagram of an example hardware implementation for accelerated approximations of functions with a fixed-point operand according to some embodiments of the present disclosure. The input operands of a hardware block include a fixed-point input 402 in a sign-magnitude representation using a sign bit 404, and an instruction mask 406 that controls which function is to be approximated. The sign bit 404 and the instruction mask 406 are used to generate control signals using the control lookup 407 that select which function is to be approximated. The fixed-point input 402 gets shifted in two shift blocks 408,410 by a fixed amount. The control signals determine whether the multiplexer (MUX) 412 selects either the direct or first shifted fixed-point input. The control signals also determine whether the second shifted input is passed on directly or is forced to 0 in the logical mask 414 block. The first adder 416 then calculates the difference of the two values. (In another embodiment, the adder 416 may be controlled by a control signal to compute either the difference or the sum of the two values.) The result of the adder 416 is passed to the exponential block 418 to calculate two to the negative power of the adder result. Then the second adder 420 takes the result of the exponentiation block 418, and, depending on the control signals via the logical mask 421, it either adds or subtracts a constant generated by the constant block 419 to produce an output 422. In various embodiments, the wide lines could be fixed-point or floating-point values. In particular, the solid wide lines could be fixed-point and the dashed wide lines could be floating-point. In other embodiments, a floating-point input is converted to fixed point and then used as the fixed-point input in FIG. 4.

The approximated hyperbolic tangent function, approximated sigmoid function, and approximated ELU function, as well as derivatives thereof, may be used in a variety of applications. Such applications may include image processing such as contrast enhancement. Such applications may also include optimizations used in classical machine learning or business analytics. Such applications may further include machine learning or artificial intelligence applications, including training of machine learning models such as neural networks and inferences using those machine learning models. Particularly, the use of these more computationally efficient functions may allow for these applications to be implemented on lower power devices such as mobile devices. For example, retraining of neural networks may be performed on lower power devices where such operations were restricted by the resources of these devices.

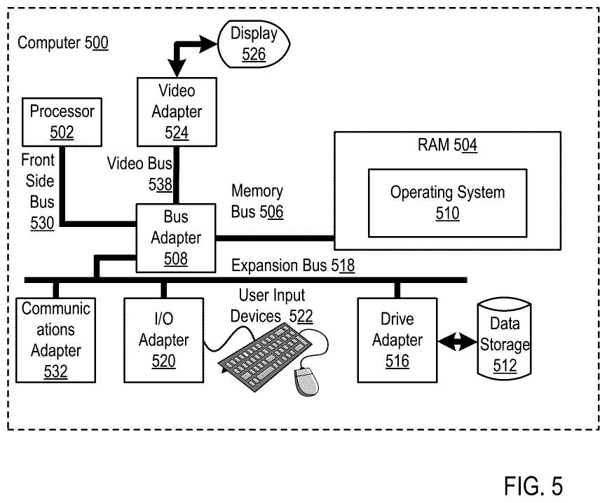

Accelerated approximations of functions in accordance with the present application is generally implemented with computers, that is, with automated computing machinery. Therefore, FIG. 5 sets forth a block diagram of computing machinery including an exemplary computer 500 configured for accelerated approximations of functions according to certain embodiments. The computer 500 of FIG. 5 includes at least one computer processor 502 or ‘CPU’ as well as random access memory 504 (‘RAM’) which is connected through a high speed memory bus 506 and bus adapter 508 to processor 502 and to other components of the computer 500.

Stored in RAM 504 is an operating system 510. Operating systems useful in computers configured for accelerated approximations of functions according to certain embodiments include UNIX™, Linux™. Microsoft Windows™, and others as will occur to those of skill in the art. The operating system 510 in the example of FIG. 5 is shown in RAM 504, but many components of such software typically are stored in non-volatile memory also, such as, for example, on data storage 512, such as a disk drive.

The computer 500 of FIG. 5 includes disk drive adapter 516 coupled through expansion bus 518 and bus adapter 508 to processor 502 and other components of the computer 500. Disk drive adapter 516 connects non-volatile data storage to the computer 500 in the form of data storage 512. Disk drive adapters useful in computers configured for accelerated approximations of functions according to certain embodiments include Integrated Drive Electronics (‘IDE’) adapters, Small Computer System Interface (‘SCSI’) adapters, and others as will occur to those of skill in the art. In some embodiments, non-volatile computer memory is implemented as an optical disk drive, electrically erasable programmable read-only memory (so-called ‘EEPROM’ or ‘Flash’ memory), RAM drives, and so on, as will occur to those of skill in the art.

The example computer 500 of FIG. 5 includes one or more input/output (′I/O′) adapters 520. I/O adapters implement user-oriented input/output through, for example, software drivers and computer hardware for controlling output to display devices such as computer display screens, as well as user input from user input devices 522 such as keyboards and mice. The example computer 500 of FIG. 5 includes a video adapter 524, which is an example of an I/O adapter specially designed for graphic output to a display device 526 such as a display screen or computer monitor. Video adapter 524 is connected to processor 502 through a high speed video bus 538, bus adapter 508, and the front side bus 530, which is also a high speed bus.

The exemplary computer 500 of FIG. 5 includes a communications adapter 532 for data communications with other computers and for data communications with a data communications network. Such data communications are carried out serially through RS-232 connections, through external buses such as a Universal Serial Bus (‘USB’), through data communications networks such as IP data communications networks, and/or in other ways as will occur to those of skill in the art. Communications adapters implement the hardware level of data communications through which one computer sends data communications to another computer, directly or through a data communications network. Examples of communications adapters useful in computers configured for accelerated approximations of functions according to certain embodiments include modems for wired dial-up communications, Ethernet (IEEE 802.3) adapters for wired data communications, and 802.11 adapters for wireless data communications.

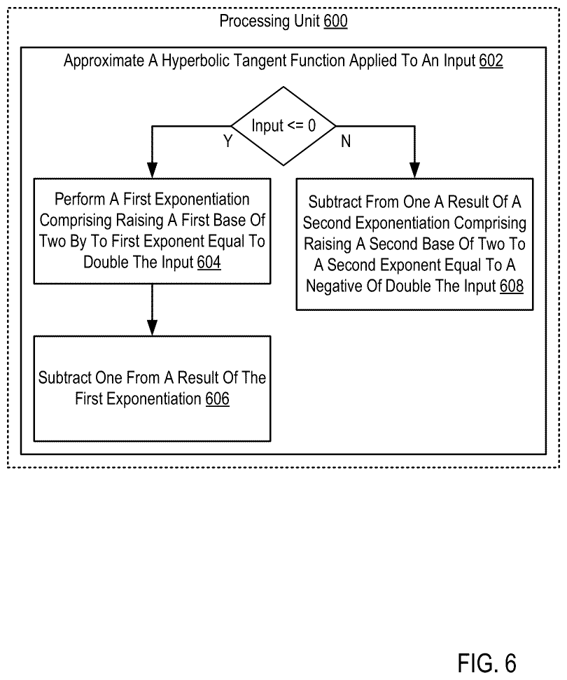

For further explanation, FIG. 6 shows a flowchart of an example method for accelerated approximations of functions according to some embodiments of the present disclosure. The method of FIG. 6 may be performed, for example, using a processing unit 600. The method of FIG. 6 includes approximating 602 a hyperbolic tangent applied to an input. A hyperbolic tangent function may be approximated 602 using the function

$${f}_{1} ( x ) = \{ \begin{matrix}{2}^{2 x} - 1 , x \leq 0 \\ 1 - {2}^{- 2 x} , x > 0\end{matrix} .$$

Accordingly, the operations applied to the input x may depend on whether the input x is greater than, less than, or equal to zero. Where the input x is less than or equal zero, the method of FIG. 6 may include performing 604 a first exponentiation comprising raising a first base of two to a first exponent equal to double the input. The method of FIG. 6 may then also include subtracting 606 one from the result of the first exponentiation. Where the input is greater than zero, the method of FIG. 6 may include subtracting 608 from one a result of a second exponentiation whereby a second base of two is raised to a second exponent equal to a negative of double the input.

In contrast to a hyperbolic tangent function, the approximated hyperbolic tangent function lacks expensive division and exponentiation operations. Instead, the approximated hyperbolic tangent function includes only subtraction operations as well as multiplication and exponentiations that can be efficiently performed using bit shift operations. Accordingly, the approximated hyperbolic tangent function has greater computational efficiency compared to a hyperbolic tangent function while maintaining accuracy.

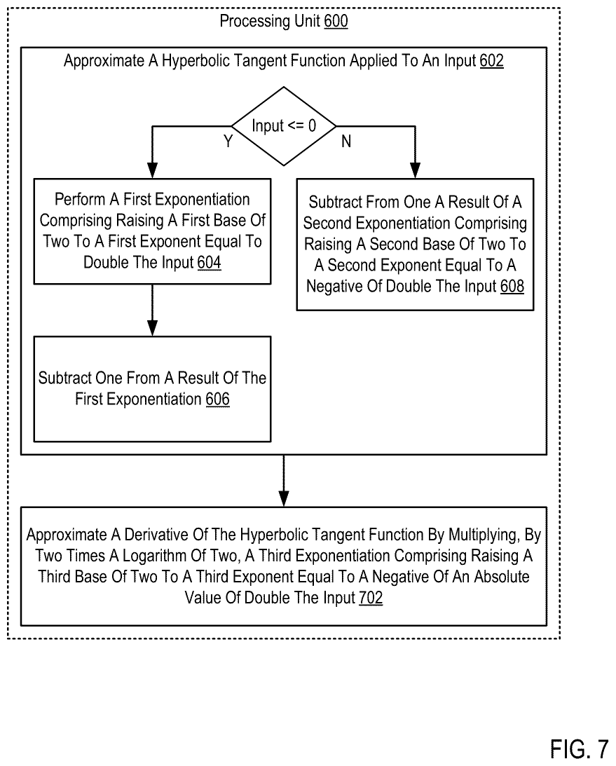

For further explanation, FIG. 7 sets forth a flowchart of another example method of accelerated approximations of functions in accordance with some embodiments of the present disclosure. The method of FIG. 7 is similar to FIG. 6 in that the method of FIG. 7 also includes approximating 602 a hyperbolic tangent function applied to an input, including: where the input is less than or equal zero, performing 604 a first exponentiation comprising raising a first base of two to a first exponent equal to double the input; and subtracting 606 one from the result of the first exponentiation; or, where the input is greater than zero, subtracting 608 from one a result of a second exponentiation whereby a second base of two is raised to a second exponent equal to a negative of double the input.

The method of FIG. 7 differs from FIG. 6 in that the method of FIG. 7 includes approximating 702 a derivative of the hyperbolic tangent function by multiplying, by two times a logarithm of two, a third exponentiation comprising raising a third base of two to a third exponent equal to a negative of an absolute value of double the input. The approximation of the derivative of the hyperbolic tangent function is equal to the derivative of the approximation of the hyperbolic tangent function. As with the approximated hyperbolic tangent function, the approximation of the derivative of the hyperbolic tangent function lacks expensive division and exponentiation operations, thereby improving the overall computational efficiency while maintaining accuracy. This allows applications that use the derivative of the hyperbolic tangent function, such as in machine learning training or inference, to be efficiently implemented for use on lower power devices including mobile devices.

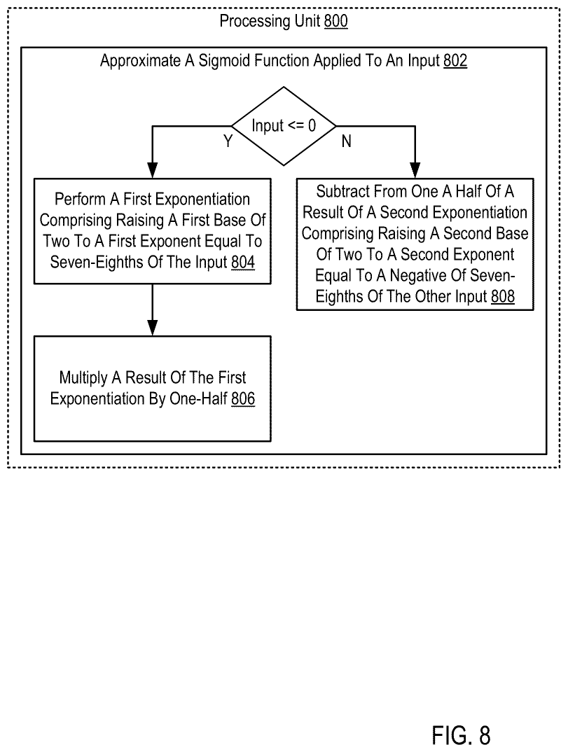

For further explanation, FIG. 8 sets forth a flowchart of accelerated approximations of functions in accordance with some embodiments of the present disclosure. The method of FIG. 8 may be performed, for example, using a processing unit 800. The method of FIG. 8 includes approximating 802 a sigmoid function applied to an input. A sigmoid function may be approximated using the function

$${f}_{2} ( x ) = \{ \begin{matrix}0.5 \cdot {2}^{0.875 x} , x \leq 0 \\ 1 - 0.5 \cdot {2}^{- 0.875 x} , x > 0\end{matrix} .$$

Accordingly, the operations applied to the input x may depend on whether the input x is greater than, less than, or equal to zero. Where the input x is less than or equal to zero, the method of FIG. 8 may include performing 804 a first exponentiation comprising raising a first base of two to a first exponent equal to seven-eighths of the input. The method of FIG. 8 may also include multiplying 806 a result of the first exponentiation by one-half. Where the input is greater than zero, the method of FIG. 8 may include subtracting 806 from one a half of a result of a second exponentiation comprising raising a second base of two to a second exponent equal to a negative of seven-eighths of the other input 808.

In contrast to a sigmoid function, the approximated sigmoid function lacks expensive division and exponentiation operations. Instead, the approximated sigmoid function includes only subtraction operations as well as multiplication and exponentiations that can be efficiently performed using bit shift operations. Accordingly, the approximated sigmoid function has greater computational efficiency compared to a sigmoid function while maintaining accuracy.

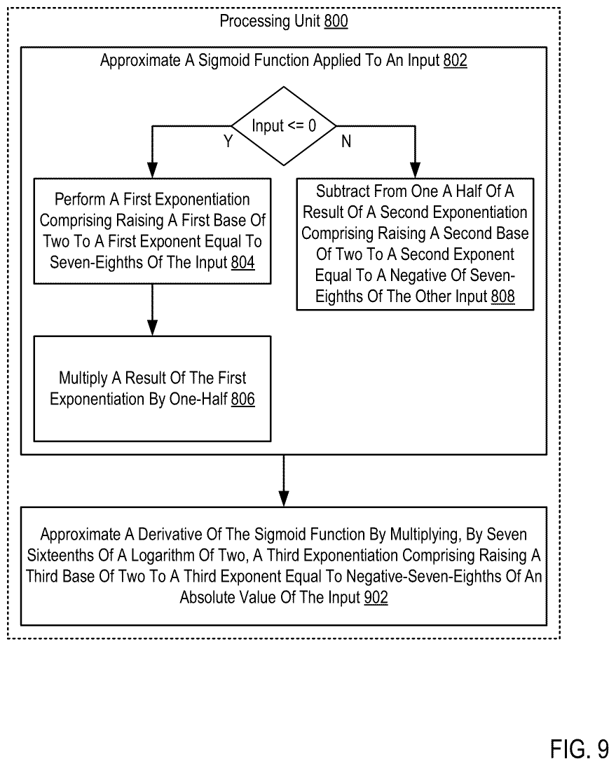

For further explanation, FIG. 9 sets forth a flowchart of an example method of accelerated approximations of functions in accordance with some embodiments of the present disclosure. The method of FIG. 9 is similar to FIG. 8 in that the method of FIG. 9 also includes: approximating 802 a sigmoid function applied to an input, including: where the input x is less than or equal to zero, performing 804 a first exponentiation comprising raising a first base of two to a first exponent equal to seven-eighths of the input; and multiplying 806 a result of the first exponentiation by one-half; or, where the input is greater than zero, subtracting 806 from one a half of a result of a second exponentiation comprising raising a second base of two to a second exponent equal to a negative of seven-eighths of the other input 808.

The method of FIG. 9 differs from FIG. 8 in that the method of FIG. 9 also includes: approximating 902 a derivative of the sigmoid function by multiplying, by seven sixteenths of a logarithm of two, a third exponentiation comprising raising a third base of two to a third exponent equal to negative-seven-eighths of an absolute value of the input. The approximation of the derivative of the sigmoid function is equal to the derivative of the approximation of the sigmoid function. As with the approximated sigmoid function, the approximation of the derivative of the sigmoid function lacks expensive division and exponentiation operations, thereby improving the overall computational efficiency while maintaining accuracy. This allows applications that use the derivative of the sigmoid function, such as in machine learning training or inference, to be efficiently implemented for use on lower power devices including mobile devices.

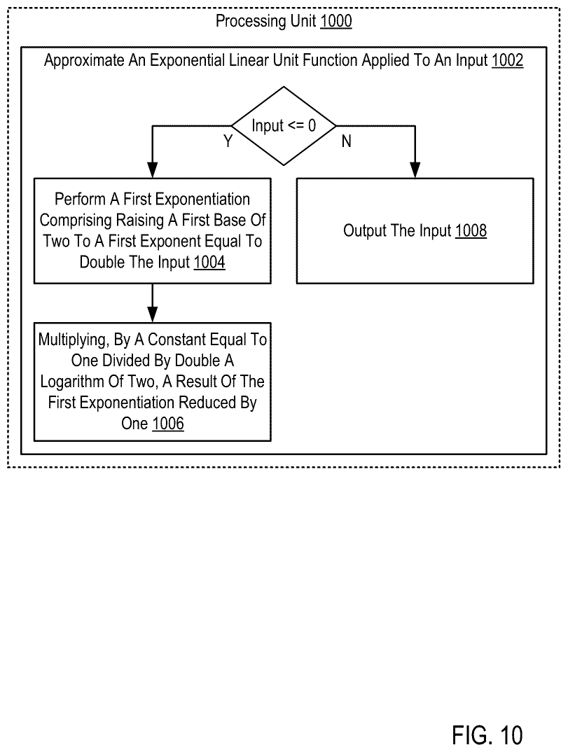

For further explanation, FIG. 10 sets forth a flowchart of accelerated approximations of functions in accordance with some embodiments of the present disclosure. The method of FIG. 10 may be performed, for example, using a processing unit 100. The method of FIG. 10 includes approximating 1002 an exponential linear unit (ELU) function applied to an input. An ELU function may be approximated using the function

$${f}_{3} ( x ) = \{ \begin{matrix}\frac{1}{2 log 2} ( {2}^{2 x} - 1 ) , x \leq 0 \\ x , x > 0\end{matrix} .$$

Accordingly, the operations applied to the input x may depend on whether the input x is greater than, less than, or equal to zero. Where the input x is less than or equal to zero, the method of FIG. 10 may include performing 1004 a first exponentiation comprising raising a first base of two to a first exponent equal to double the input. The method of FIG. 10 may also include multiplying 1006, by a constant equal to one divided by double a logarithm of two, a result of the first exponentiation reduced by one. Where the input is greater than zero, the method of FIG. 8 may include outputting 1008 the input.

In contrast to an ELU function, the approximated ELU function lacks expensive exponentiation operations. Instead, the approximated ELU function includes only subtraction operations as well as multiplication and exponentiations that can be efficiently performed using bit shift operations. Accordingly, the approximated ELU function has greater computational efficiency compared to a ELU function while maintaining accuracy.

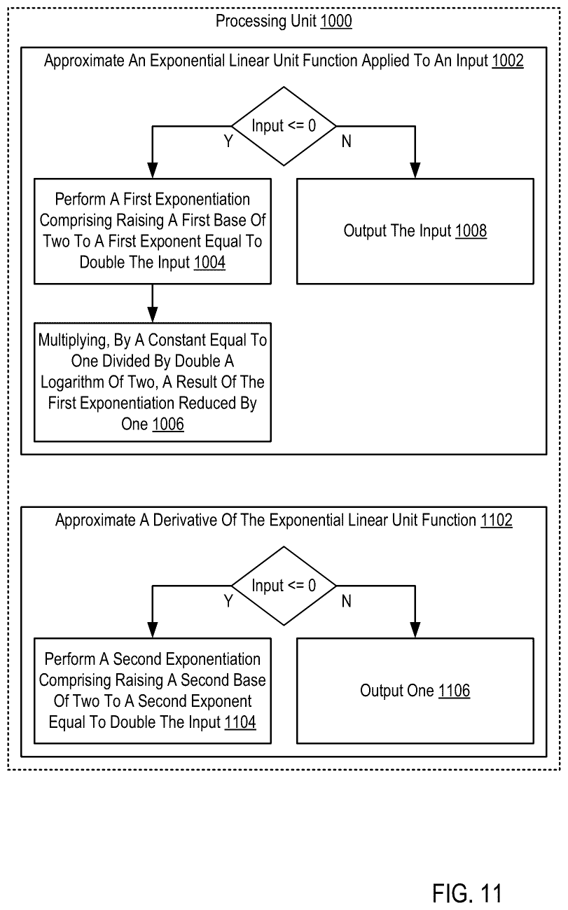

For further explanation, FIG. 11 sets forth a flowchart of an example method of accelerated approximations of functions in accordance with some embodiments of the present disclosure. The method of FIG. 11 is similar to FIG. 10 in that the method of FIG. 11 also includes: approximating an Exponential Linear Unit function applied to an input 1002, including: where the input x is less than or equal to zero, performing 1004 a first exponentiation comprising raising a first base of two to a first exponent equal to double the input; and multiplying 1006, by a constant equal to one divided by double a logarithm of two, a result of the first exponentiation reduced by one; or, where the input is greater than zero, outputting 1008 the input.

The method of FIG. 11 differs from FIG. 10 in that the method of FIG. 11 also includes: approximating 1102 a derivative of the ELU function. The derivative of the approximated ELU function may be represented by the formula

$${f}_{3}^{′} ( x ) = \{ \begin{matrix}{2}^{2 x} , x \leq 0 \\ 1 , x > 0\end{matrix} .$$

Where the input is less than or equal to zero, the method of FIG. 11 may include performing 1104 a second exponentiation comprising raising a second base of two to a second exponent equal to double the input. Where the input is greater than zero, the method of FIG. 11 may include outputting 1106 one. As with the approximated ELU function, the approximation of the derivative of the ELU function lacks expensive exponentiation operations, thereby improving the overall computational efficiency while maintaining accuracy. This allows applications that use the derivative of the ELU function, such as in machine learning training or inference, to be efficiently implemented for use on lower power devices including mobile devices.

In view of the explanations set forth above, readers will recognize that the benefits of accelerated approximations of functions according to embodiments of the present invention include improved performance of a computing system by improved computational efficiency compared to hyperbolic tangent functions and sigmoid functions, as well as their derivatives, while maintaining accuracy.

Exemplary embodiments of the present invention are described largely in the context of a fully functional computer system for accelerated approximations of functions. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of accelerated approximations of functions, the method comprising:
approximating, by a computing device, a hyperbolic tangent function applied to an input by:
where the input is less than zero:
performing a first exponentiation comprising raising a first base of two to a first exponent equal to double the input; and
subtracting one from a result of the first exponentiation; and
where the input is greater than zero, subtracting from one a result of a second exponentiation comprising raising a second base of two by a second exponent equal to a negative of double the input.

2. The method of claim 1, wherein approximating the hyperbolic tangent function is implemented using a single hardware instruction.

3. The method of claim 1, wherein performing one or more of the first exponentiation and the second exponentiation comprises performing one or more bit shift operations.

4. The method of claim 1, further comprising approximating, by the computing device, a derivative of the hyperbolic tangent function by multiplying, by two times a logarithm of two, a third exponentiation comprising raising a third base of two to a third exponent equal to a negative of an absolute value of double the input.

5. The method of claim 4, wherein approximating the derivative of the hyperbolic tangent function is implemented using a single hardware instruction and one or more mask bits.

6. The method of claim 1, further comprising:
approximating, by the computing device, a sigmoid function applied to another input by:
where the other input is less than zero:
performing a third exponentiation comprising raising a third base of two to a third exponent equal to seven-eighths of the other input; and
multiplying a result of the third exponentiation by one-half; and
where the other input is greater than zero, subtracting from one a half of a result of a fourth exponentiation comprising raising a fourth base of two to a fourth exponent equal to a negative of seven-eighths of the other input.

7. The method of claim 6, further comprising approximating, by the computing device, a derivative of the sigmoid function by multiplying, by seven-sixteenths of a logarithm of two, a fifth exponentiation comprising raising a fifth base of two to a fifth exponent equal to negative-seven-eighths of an absolute value of the other input.

8. The method of claim 1, wherein approximating the hyperbolic tangent function comprises performing, by approximating the hyperbolic tangent function, one or more of: an image processing, a machine learning training, or a machine learning inference.

9. A method of accelerated approximations of functions, the method comprising:
approximating, by a computing device, a sigmoid function applied to an input by:
where the input is less than zero:
performing a first exponentiation comprising raising a first base of two to a first exponent equal to seven-eighths of the input; and
multiplying a result of the first exponentiation by one-half; and
where the input is greater than zero, subtracting from one a half of a result of a second exponentiation comprising raising a second base of two to a second exponent equal to a negative of seven-eighths of the other input.

10. The method of claim 9, wherein approximating the sigmoid function is implemented using a single hardware instruction.

11. The method of claim 9, wherein performing one or more of the first exponentiation and the second exponentiation comprises performing one or more bit shift operations.

12. The method of claim 9, further comprising approximating, by the computing device, a derivative of the sigmoid function by multiplying, by seven-sixteenths of a logarithm of two, a third exponentiation comprising raising a third base of two to a third exponent equal to negative-seven-eighths of an absolute value of the input.

13. The method of claim 12, wherein approximating the derivative of the sigmoid function is implemented using a single hardware instruction and one or more mask bits.

14. The method of claim 9, further comprising:
approximating, by the computing device, a hyperbolic tangent function applied to another input by:
where the other input is less than zero:
performing a third exponentiation comprising raising a third base of two to a third exponent equal to double the input; and
subtracting one from a result of the third exponentiation; and
where the other input is greater than zero, subtracting from one a result of a fourth exponentiation comprising raising a fourth base of two to a fourth exponent equal to a negative of double the other input.

15. The method of claim 9, further comprising approximating, by the computing device, a derivative of the hyperbolic tangent function by multiplying, by two times a logarithm of two, a fifth exponentiation comprising raising a fifth base of two to a fifth exponent equal to a negative of an absolute value of double the other input.

16. The method of claim 9, wherein approximating the sigmoid function comprises performing, by approximating the sigmoid function, one or more of: an image processing, a machine learning training, or a machine learning inference.

17. A method of accelerated approximations of functions, the method comprising:
approximating, by a computing device, an exponential linear unit (ELU) function applied to an input by:
where the input is less than zero:
performing a first exponentiation comprising raising a first base of two to a first exponent equal to double the input; and
multiplying, by a constant equal to one divided by double a logarithm of two, a result of the first exponentiation reduced by one; and
where the input is greater than zero, outputting the input.

18. The method of claim 17, further comprising:
approximating, by the computing device, a derivative of the ELU function by:
where the input is less than zero:
performing a second exponentiation comprising raising a first base of two to a second exponent equal to double the input; and
where the input is greater than zero, outputting one.

19. The method of claim 17, further comprising:
approximating, by the computing device, a hyperbolic tangent function applied to another input by:
where the other input is less than zero:
performing a second exponentiation comprising raising a second base of two to a second exponent equal to double the input; and
subtracting one from a result of the second exponentiation; and
where the other input is greater than zero, subtracting from one a result of a third exponentiation comprising raising a third base of two to a third exponent equal to a negative of double the other input.

20. The method of claim 17, further comprising:
approximating, by the computing device, a hyperbolic tangent function applied to another input by:
where the other input is less than zero:
performing a second exponentiation comprising raising a third base of two to a third exponent equal to double the input; and
subtracting one from a result of the second exponentiation; and
where the other input is greater than zero, subtracting from one a result of a third exponentiation comprising raising a third base of two to a third exponent equal to a negative of double the other input.
